(19) United States
(12) Patent Application Publication
(10) Pub. No.: US 2020/0076215 A1
(43) Pub. Date: Mar. 5, 2020

(54) INTELLIGENT MULTI-POINT CHARGING CIRCUIT AND CHARGING DEVICE

(71) Applicant: NINGBO LONGTU NETWORK TECHNOLOGY CO., LTD, Cixi (CN)

(72) Inventor: Dijiao Shen, Cixi (CN)

(73) Assignee: NINGBO LONGTU NETWORK TECHNOLOGY CO., LTD

(21) Appl. No.: 16/675,239

(22) Filed: Nov. 6, 2019

(30) Foreign Application Priority Data
Mar. 15, 2019 (CN) 201910197757.7
Mar. 15, 2019 (CN) 201920330192.0

(51) Int. Cl. H02J 7/00

(52) U.S. Cl. CPC H02J 7/0045; H02J 7/0047; H02J 7/0029

(57) ABSTRACT

The present invention discloses an intelligent multi-point charging circuit and a charging device, which comprises a main control circuit, a current monitor circuit, a port selection circuit, a relay control circuit, at least one relay, at least one charging port, and an overload and short-circuit protection circuit. According to the technical scheme provided by the present invention, a plurality of power utilization equipment to be charged can be simultaneously connected, self-adaptive adjustment is carried out according to the charging conditions of the plurality of power utilization equipment to be charged, and the charging of the power utilization equipment to be charged in batches may be completed without personnel on duty.

### TECHNICAL FIELD

The present invention relates to the technical field of circuits, and in particular to an intelligent multi-point charging circuit and a charging device.

### BACKGROUND

According to the charging circuit in the prior art, in most cases, one charging equipment can only charge one power utilization equipment to be charged at the same time, and after one power utilization equipment to be charged is charged, the next power utilization equipment to be charged is charged by switching. In this case, a person needs to be attended beside the charger to switch the power utilization equipment to be charged. However, the personnel are kept beside the charger, and once the personnel are not kept hard, the switching interval time of the power utilization equipment to be charged may be long, so that the overall charging time of the power utilization equipment to be charged in batches will be prolonged. In order to reduce the switching interval time of the power utilization equipment to be charged, some chargers are provided with a charging indicator or a charging completion alarm function, in this case, the personnel on duty only needs to observe the indicator to know whether the charging is completed or not. But it is possible that the personnel on duty is not timely observed, so that the overall charging time of the power utilization equipment to be charged in batches is long. In addition, the operation of switching the power utilization equipment to be charged requires low technology content, which inevitably causes the waste of human resources.

### SUMMARY OF THE INVENTION

Therefore, the present invention provides an intelligent multi-point charging circuit, which may be utilized for simultaneously connecting a plurality of power utilization equipment to be charged, and may carry out self-adaptive adjustment according to the charging conditions of the plurality of power utilization equipment to be charged, so that the charging of the power utilization equipment to be charged in batches may be completed without personnel on duty. This makes it more practical.

In order to achieve the above object, the intelligent multi-point charging circuit provided by the present invention includes a main control circuit, a current monitor circuit, a port selection circuit, a relay control circuit, at least one relay, at least one charging port, and an overload and short-circuit protection circuit;

the relays are connected with the charging ports in one-to-one correspondence;

when the relay is closed, the charging port correspondingly connected with the closed relay is in an on state, so that power utilization equipment to be charged connected to the charging port may be connected to the intelligent multi-point charging circuit; when the relay is turned off, the charging port correspondingly connected with the turned off relay is in an off state, so that power utilization equipment to be charged connected to the charging port may be disconnected from the intelligent multi-point charging circuit;

the current monitor circuit is configured for monitoring currents flowing through each of the charging ports in an on state and sending current data to the main control circuit;

the main control circuit calculates the sum of the currents flowing through the charging ports according to the current data received; the main control circuit sends out a relay control instruction by comparing the sum of the currents and a preset current threshold value; the relay control circuit controls the relays to be closed or turned off according to the relay control instruction, so that the power utilization equipment to be charged may be connected to or disconnected from the intelligent multi-point charging circuit;

when the main control circuit sends out a relay control instruction, a port instruction is sent to the port selection circuit, and the port selection circuit transmits the port instruction to the current monitor circuit, and the current monitor circuit monitors currents of the charging ports in an on state according to the port instruction.

Preferably, when the sum of the currents is greater than the preset current threshold value, the main control circuit sends out a relay control instruction; and the relay control circuit controls part of the relays to be turned off according to the relay control instruction, so that the power utilization equipment to be charged is disconnected; when the sum of the currents is not greater than the preset current threshold value, the main control circuit sends out a relay control instruction; and the relay control circuit controls part of the relays to be closed according to the relay control instruction, so that the power utilization equipment to be charged is connected.

Preferably, the intelligent multi-point charging circuit further includes LED indicators and an LED display control circuit; and the LED indicators are configured for indicating the states of the charging ports.

Preferably, the LED indicators include a red indicator and a green indicator, where a flashing state of the red indicator indicates that the charging port corresponding to the red indicator is in a fault state, a constant-on state of the red indicator indicates that the charging port corresponding to the red indicator is in a working state, and a constant-on state of the green indicator indicates that the charging port corresponding to the green indicator is in a standby state.

Preferably, the LED display control circuit and the relay control circuit are integrated in a same sub-circuit or chip.

Preferably, the main control circuit includes a slave station main control circuit and a master station main control circuit. The slave station main control circuit receives current data of each of the charging ports in an on state and sends the current data to the master station main control circuit, and the master station main control circuit sends out the relay control instruction to the slave station main control circuit, and the slave station main control circuit generates the port selection instruction according to the relay control instruction received.

Preferably, the intelligent multi-point charging circuit further includes an overload and short-circuit protection circuit configured for starting fault protection when an overload or short-circuit fault occurs at the charging ports.

Preferably, the overload and short-circuit protection circuit is a fuse.

The present invention also provides an intelligent multi-point charging device, including the above-mentioned intelligent multi-point charging circuit, and further including a leakage protection circuit and an anti-surge protection circuit.

Preferably, the leakage protection circuit and/or the anti-surge protection circuit are provided on the intelligent multi-point charging circuit or the power utilization equipment to be charged.

The intelligent multi-point charging circuit and the charging device provided by the present invention include a main control circuit, a current monitor circuit, a port selection circuit, a relay control circuit, at least one relay, at least one charging port, and an overload and short-circuit protection circuit; the current monitor circuit is configured for monitoring currents flowing through each of the charging ports in an on state and sending current data to the main control circuit; the main control circuit calculates the sum of the currents flowing through the charging ports according to the current data received; the main control circuit sends out a relay control instruction to the relay control circuit by comparing the sum of the currents and the preset current threshold value; the relay control circuit controls the relays to be closed or turned off according to the relay control instruction, so that the power utilization equipment to be charged may be connected to or disconnected from the intelligent multi-point charging circuit; according to the technical scheme provided by the present invention, a plurality of power utilization equipment to be charged may be simultaneously connected, self-adaptive adjustment is carried out according to the charging conditions of the plurality of power utilization equipment to be charged, and the charging of the power utilization equipment to be charged in batches may be completed without personnel on duty.

### BRIEF DESCRIPTION OF THE DRAWINGS

Various other advantages and benefits will become apparent to those of ordinary skill in the art upon reading the following detailed description of the preferred embodiment modes. The drawings are only for the purpose of illustrating preferred embodiment modes and are not to be construed as limiting the present invention. Also, throughout the drawings, like reference numerals designate like components. In the drawings:

FIG. 1 is a schematic diagram 1 of an intelligent multi-point charging circuit according to embodiments of the present invention;

FIG. 2 is a schematic diagram 2 of an intelligent multi-point charging circuit according to embodiments of the present invention.

### DETAILED DESCRIPTION OF EMBODIMENTS

In order to solve the problems in the prior art, the present invention provides an intelligent multi-point charging circuit, which may be utilized for simultaneously connecting a plurality of power utilization equipment to be charged, and may carry out self-adaptive adjustment according to the charging conditions of the plurality of power utilization equipment to be charged, so that the charging of the power utilization equipment to be charged in batches may be completed without personnel on duty. This makes it more practical.

In order to further illustrate the technical means and efficacy of the present invention to achieve the intended purpose of the invention, an intelligent multi-point charging circuit according to the present invention, and the specific embodiment modes, structure, characteristics and efficacy thereof will be described in detail hereinafter with reference to the drawings and preferred embodiments. In the following description, different “an embodiment” or “embodiment” means not necessarily the same embodiment. Furthermore, the features, structures, or characteristics of one or more embodiments may be combined in any suitable form.

The term “and/or” herein is merely an association that describes an associated object, meaning that there may be three relationships, e.g., A and/or B, specifically understood as: A and B may be included at the same time, A may be present alone or B may be present alone, and any of the above three cases may be provided.

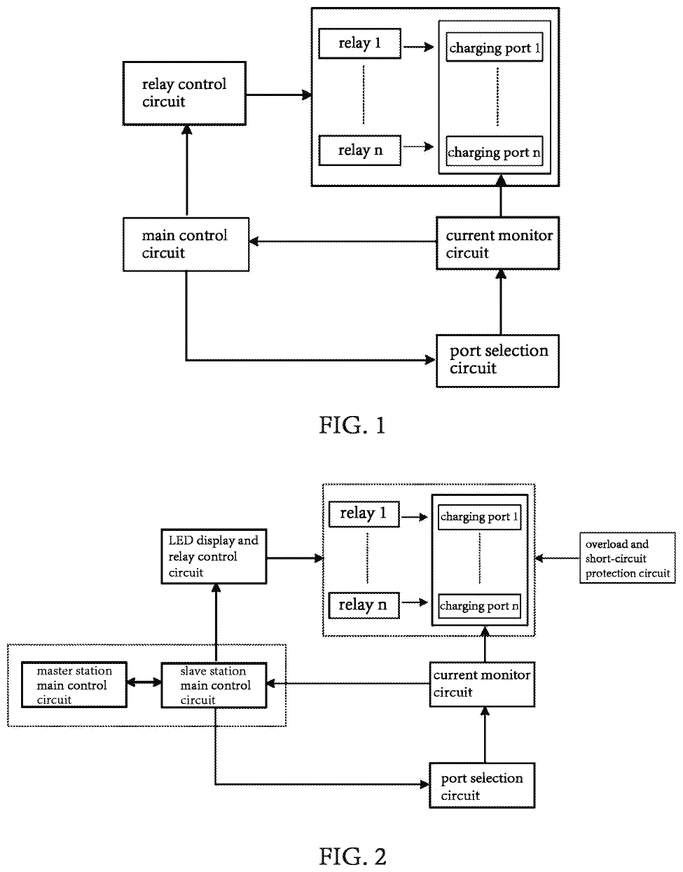

Referring to FIG. 1, the intelligent multi-point charging circuit provided by the embodiments of the present invention includes a charging main control circuit, a current monitor circuit, a port selection circuit, a relay control circuit, n relays, n charging ports, and an overload and short-circuit protection circuit; in which,

the relays are connected with the charging ports in one-to-one correspondence; n is a positive integer greater than or equal to 1.

When the relay is closed, the charging port correspondingly connected with the closed relay is in an on state, so that power utilization equipment to be charged connected to the charging port may be connected to the intelligent multi-point charging circuit; when the relay is turned off, the charging port correspondingly connected with the turned off relay is in an off state, so that power utilization equipment to be charged connected to the charging port may be disconnected from the intelligent multi-point charging circuit;

the current monitor circuit is configured for monitoring currents flowing through each of the charging ports in an on state and sending current data to the main control circuit;

the main control circuit calculates the sum of the currents flowing through the charging ports according to the current data received; the main control circuit sends out a relay control instruction by comparing the sum of the currents and a preset current threshold value; the relay control circuit controls the relays to be closed or turned off according to the relay control instruction, so that the power utilization equipment to be charged may be connected to or disconnected from the intelligent multi-point charging circuit;

when the main control circuit sends out a relay control instruction, a port instruction is sent to the port selection circuit, and the port selection circuit transmits the port instruction to the current monitor circuit, and the current monitor circuit monitors currents of the charging ports in an on state according to the port instruction.

Further, the main control circuit sends out a relay control instruction by comparing the sum of the currents and the preset current threshold value; the relay control circuit controls the relays to be closed or turned off according to the relay control instruction, so that the power utilization equipment to be charged may be connected to or disconnected from the intelligent multi-point charging circuit, which specifically includes:

when the sum of the currents is greater than the preset current threshold value, the main control circuit sends out a relay control instruction; and the relay control circuit controls part of the relays to be turned off according to the relay control instruction, so that the power utilization equipment to be charged is disconnected;

when the sum of the currents is not greater than the preset current threshold value, the main control circuit sends out a relay control instruction; and the relay control circuit controls part of the relays to be closed according to the relay control instruction, so that the power utilization equipment to be charged is connected.

The intelligent multi-point charging circuit provided by the embodiments of the present invention includes a main control circuit, a current monitor circuit, a port selection circuit, a relay control circuit, at least one relay, at least one charging port, and an overload and short-circuit protection circuit; the current monitor circuit is configured for monitoring currents flowing through each of the charging ports in an on state and sending current data to the main control circuit; the main control circuit calculates the sum of the currents flowing through the charging ports according to the current data received; the main control circuit sends out a relay control instruction to the relay control circuit by comparing the sum of the currents and the preset current threshold value; the relay control circuit controls the relays to be closed or turned off according to the relay control instruction, so that the power utilization equipment to be charged may be connected to or disconnected from the intelligent multi-point charging circuit; according to the technical scheme provided by the present invention, a plurality of power utilization equipment to be charged may be simultaneously connected, self-adaptive adjustment is carried out according to the charging conditions of the plurality of power utilization equipment to be charged, and the charging of the power utilization equipment to be charged in batches may be completed without personnel on duty.

Other embodiments of the present invention may refer to FIG. 2, as a preferred scheme of the previous embodiment, the intelligent multi-point charging circuit further includes LED indicators and an LED display control circuit; and the LED indicators are configured for indicating the states of the charging ports.

Further, the LED indicators include a red indicator and a green indicator, where a flashing state of the red indicator indicates that the charging port corresponding to the red indicator is in a fault state, a constant-on state of the red indicator indicates that the charging port corresponding to the red indicator is in a working state, and a constant-on state of the green indicator indicates that the charging port corresponding to the green indicator is in a standby state.

In this case, the power utilization equipment to be charged connected with the charging port does not need to be unplugged for inspection, and the charging state of the power utilization equipment to be charged connected with the corresponding charging port may be known only by the states of the indicators (the flashing state of the red indicator, the constant-on state of the red indicator and the constant-on state of the green indicator). When the red indicator flashes, the corresponding fault port should be repaired. When the green indicator is turned on, the power utilization equipment to be charged which is completely charged should be timely unplugged.

The indicators are LED indicators. A light emitting diode is simply referred to as an LED. It is manufactured of compounds containing gallium (Ga), arenic (As), phosphorus (P), nitrogen (N), etc. When electrons and holes are recombined, visible light may be radiated, and therefore the light emitting diode may be manufactured. The light emitting diode may be used as an indicator in circuits and instruments, or it may be displayed in combined words or numbers. A gallium arsenide diode emits red light, a gallium phosphide diode emits green light, a silicon carbide diode emits yellow light, and a gallium nitride diode emits blue light. The LEDs may be divided into organic light emitting diodes (OLEDs) and inorganic light emitting diodes (ILEDs) by their chemical properties. The LED has the following advantages: (1) small volume: the LED is substantially a small wafer packaged in epoxy resin, so that the LED is very small and light; (2) low power consumption: the LED has a quite low power consumption, DC drive and ultra-low power consumption (single tube 0.03-0.06 W), and electro-optical power conversion is close to 30%. Generally, the operating voltage of the LED is 2-3.6 V, and the operating current is 0.02-0.03 A; That is, it consumes no more than 0.1 W of electric energy, and the same illumination effect saves approximately 80% of energy compared with a conventional light source. (3) Long service life: the LED light source is known as a long-life lamp. The LED light source is a solid cold light source packaged by epoxy resin, and there are no loose parts in the lamp body and no defects such as easy burning of filament luminescence, thermal deposition, light attenuation and the like. Under a proper current and a proper voltage, its service life may be up to 60,000 to 100,000 hours, which is more than 10 times longer than that of a conventional light source. (4) High brightness and low heat: the LED utilizes a cold light emitting technology, and the heating value is much lower than that of an ordinary lighting lamp. (5) Environmental protection: the LED is manufactured of non-toxic materials that do not contaminate the environment like a fluorescent lamp with mercury and it may be recycled. The spectrum has no ultraviolet rays or infrared rays, so that the LED has no heat, no radiation, a small glare and a cold light source, which means it may be touched safely and considered as a typical green illumination light source. (6) Being firm and durable: the LED is completely packaged within epoxy resin, so that it is stronger than both a bulb and a fluorescent tube. Also, the lamp body has no loose parts, so that the LED is not easy to damage. (7) Advanced technologies: the LED light source is a low voltage microelectronic product compared to the monotonous lighting effect of a conventional light source. It has successfully integrated computer technology, network communication technology, image processing technology, embedded control technology and so on, therefore it is also a digital information product and a semiconductor optoelectronic device “high-tech” technology with the characteristics of online programming, unlimited upgrading, flexibility and variability.

Furthermore, the LED display control circuit and the relay control circuit may be integrated in a same sub-circuit or chip, so that the size and the cost of the intelligent multi-point charging circuit are further reduced.

As another embodiment of the present invention, the main control circuit includes a slave station main control circuit and a master station main control circuit, wherein the slave station main control circuit receives current data of each of the charging ports in an on state and sends the current data to the master station main control circuit, and the master station main control circuit sends out the relay control instruction to the slave station main control circuit after processing and judging the current data, and the slave station main control circuit generates the port selection instruction according to the relay control instruction received. The relay control circuit controls the relays to be closed or turned off according to the relay control instruction, so that the power utilization equipment to be charged may be connected to or disconnected from the intelligent multi-point charging circuit; and the port selection circuit transmits the port instruction to the current monitor circuit, and the current monitor circuit monitors currents of the charging ports in an on state according to the port instruction.

Further, the intelligent multi-point charging circuit provided by the embodiments of the present invention further includes an overload and short-circuit protection circuit for starting fault protection when an overload or short-circuit fault occurs at the charging ports. In practice, the overload and short-circuit protection circuit may be selected as a fuse.

Furthermore, the embodiments of the present invention also provide an intelligent multi-point charging device which includes an leakage protection circuit and an anti-surge protection circuit in addition to the intelligent multi-point charging devices in the above-mentioned embodiments. The leakage protection circuit and the anti-surge protection circuit may be provided on the intelligent multi-point charging circuit and in the power utilization equipment to be charged. When provided on the intelligent multi-point charging circuit, the leakage protection circuit and the anti-surge protection circuit are provided near the charging port; when provided in the power utilization equipment to be charged, the leakage protection circuit and the anti-surge protection circuit are provided near the input port of the power utilization equipment to be charged.

According to the intelligent multi-point charging circuit and the charging device provided by the embodiments of the present invention, a plurality of power utilization equipment to be charged may be simultaneously connected, self-adaptive adjustment and dynamic allocation are carried out according to the charging conditions of the plurality of power utilization equipment to be charged, and the charging of the power utilization equipment to be charged in batches may be completed without personnel on duty. Manpower cost is saved, and reliability and safety of operation of the device are greatly improved through multiple protection devices.

Although the preferred embodiments of the present invention have been described, additional changes and modifications may be made to these embodiments by those skilled in the art once the basic inventive concept is known. It is therefore intended that the appended claims be interpreted as including the preferred embodiments and all such changes and modifications as fall within the true scope of the present invention.

It will be apparent to those skilled in the art that various modifications and variations may be made in the present invention without departing from the spirit or scope of the present invention. Thus, it is intended that the present invention cover the modifications and variations of this invention provided they come within the scope of the appended claims and their equivalents.

1. An intelligent multi-point charging circuit, characterized by comprising a main control circuit, a current monitor circuit, a port selection circuit, a relay control circuit, at least one relay, at least one charging port, and an overload and short-circuit protection circuit;
the relays are connected with the charging ports in one-to-one correspondence;
when the relay is closed, the charging port correspondingly connected with the closed relay is in an on state, so that power utilization equipment to be charged connected to the charging port may be connected to the intelligent multi-point charging circuit; when the relay is turned off, the charging port correspondingly connected with the turned off relay is in an off state, so that power utilization equipment to be charged connected to the charging port may be disconnected from the intelligent multi-point charging circuit;
the current monitor circuit is configured for monitoring currents flowing through each of the charging ports in an on state and sending current data to the main control circuit;
the main control circuit calculates the sum of the currents flowing through the charging ports according to the current data received; the main control circuit sends out a relay control instruction by comparing the sum of the currents and a preset current threshold value; the relay control circuit controls the relays to be closed or turned off according to the relay control instruction, so that the power utilization equipment to be charged may be connected to or disconnected from the intelligent multi-point charging circuit;
when the main control circuit sends out a relay control instruction, a port instruction is sent to the port selection circuit, and the port selection circuit transmits the port instruction to the current monitor circuit, and the current monitor circuit monitors currents of the charging ports in an on state according to the port instruction.

2. The intelligent multi-point charging circuit of claim 1, characterized in that
the main control circuit sends out a relay control instruction by comparing the sum of the currents and a preset current threshold value; the relay control circuit controls the relays to be closed or turned off according to the relay control instruction, so that the power utilization equipment to be charged may be connected to or disconnected from the intelligent multi-point charging circuit, which specifically comprises:
when the sum of the currents is greater than a preset current threshold value, the main control circuit sends out a relay control instruction; and the relay control circuit controls part of the relays to be turned off according to the relay control instruction, so that the power utilization equipment to be charged is disconnected;
when the sum of the currents is not greater than a preset current threshold value, the main control circuit sends out a relay control instruction; and the relay control circuit controls part of the relays to be closed according to the relay control instruction, so that the power utilization equipment to be charged is connected.

3. The intelligent multi-point charging circuit of claim 1, characterized by further comprising LED indicators and an LED display control circuit, wherein the LED indicators are configured for indicating the states of the charging ports.

4. The intelligent multi-point charging circuit of claim 2, characterized by further comprising LED indicators and an LED display control circuit; wherein the LED indicators are configured for indicating the states of the charging ports.

5. The intelligent multi-point charging circuit of claim 3, characterized in that the LED indicators comprise a red indicator and a green indicator, wherein a flashing state of the red indicator indicates that the charging port corresponding to the red indicator is in a fault state, a constant-on state of the red indicator indicates that the charging port corresponding to the red indicator is in a working state, and a constant-on state of the green indicator indicates that the charging port corresponding to the green indicator is in a standby state.

6. The intelligent multi-point charging circuit of claim 3, characterized in that the LED display control circuit and the relay control circuit are integrated in a same sub-circuit or chip.

7. The intelligent multi-point charging circuit of claim 1, characterized in that the main control circuit comprises a slave station main control circuit and a master station main control circuit, wherein the slave station main control circuit receives current data of each of the charging ports in an on state and sends the current data to the master station main control circuit, and the master station main control circuit sends out the relay control instruction to the slave station main control circuit, and the slave station main control circuit generates the port selection instruction according to the relay control instruction received.

8. The intelligent multi-point charging circuit of claim 7, characterized by further comprising an overload and short-circuit protection circuit configured for starting fault protection when an overload or short-circuit fault occurs at the charging port.

9. An intelligent multi-point charging device, characterized by comprising the intelligent multi-point charging circuit of claim 1, and further comprising a leakage protection circuit and an anti-surge protection circuit.

10. An intelligent multi-point charging device, characterized by comprising the intelligent multi-point charging circuit of claim 2, and further comprising a leakage protection circuit and an anti-surge protection circuit.

11. An intelligent multi-point charging device, characterized by comprising the intelligent multi-point charging circuit of claim 3, and further comprising a leakage protection circuit and an anti-surge protection circuit.

12. An intelligent multi-point charging device, characterized by comprising the intelligent multi-point charging circuit of claim 5, and further comprising a leakage protection circuit and an anti-surge protection circuit.

13. An intelligent multi-point charging device, characterized by comprising the intelligent multi-point charging circuit of claim 6, and further comprising a leakage protection circuit and an anti-surge protection circuit.

14. An intelligent multi-point charging device, characterized by comprising the intelligent multi-point charging circuit of claim 7, and further comprising a leakage protection circuit and an anti-surge protection circuit.

15. An intelligent multi-point charging device, characterized by comprising the intelligent multi-point charging circuit of claim 8, and further comprising a leakage protection circuit and an anti-surge protection circuit.

16. The intelligent multi-point charging device of claim 9, characterized in that the leakage protection circuit and/or the anti-surge protection circuit are provided on the intelligent multi-point charging circuit or the power utilization equipment to be charged.

17. The intelligent multi-point charging device of claim 10, characterized in that the leakage protection circuit and/or the anti-surge protection circuit are provided on the intelligent multi-point charging circuit or the power utilization equipment to be charged.

18. The intelligent multi-point charging device of claim 11, characterized in that the leakage protection circuit and/or the anti-surge protection circuit are provided on the intelligent multi-point charging circuit or the power utilization equipment to be charged.

19. The intelligent multi-point charging device of claim 12, characterized in that the leakage protection circuit and/or the anti-surge protection circuit are provided on the intelligent multi-point charging circuit or the power utilization equipment to be charged.

20. The intelligent multi-point charging device of claim 13, characterized in that the leakage protection circuit and/or the anti-surge protection circuit are provided on the intelligent multi-point charging circuit or the power utilization equipment to be charged.
